(19) United States
(12) Patent Application Publication
(10) Pub. No.: US 2026/0235453 A1
(43) Pub. Date: Aug. 13, 2026

(54) Temperature sensing apparatus and method having calibration mechanism

(71) Applicant: REALTEK SEMICONDUCTOR CORPORATION, Hsinchu (TW)

(72) Inventors: I-CHE OU, Hsinchu (TW); Chuan-Chu Liu, Hsinchu (TW); Zhao-Hong Tu, Hsinchu (TW)

(21) Appl. No.: 19/448,476

(22) Filed: Jan. 14, 2026

(30) Foreign Application Priority Data
Feb. 10, 2025 (TW) 114104924

(51) Int. Cl. G01K 15/00; G01K 7/01

(52) U.S. Cl. CPC G01K 15/005; G01K 7/015

(57) ABSTRACT

A temperature sensing method is provided. A first and a second voltage digital codes are configured corresponding to a first and a second temperatures. A base temperature that makes a voltage across a component of a temperature sensing circuit to be a constant is configured. A temperature difference and a digital code difference are calculated to further calculate a predetermined slope to establish a relation equation. A sensing is performed corresponding to the first temperature to generate an actual voltage digital code. A base temperature difference is calculated between the first temperature and the base temperature and an actual digital code difference between the actual voltage digital code and the first voltage digital code are calculated to further calculate a slope variation to modify the relation equation to perform temperature sensing by using the temperature sensing circuit according to the modified equation.

### BACKGROUND OF THE INVENTION

### 1. Field of the Invention

The present invention relates to a temperature sensing apparatus and a temperature sensing method having a calibration mechanism.

### 2. Description of Related Art

In integrated circuits, a temperature sensing circuit can be used to detect the temperature of the chip or the environment so as to adjust the operation of the chip based on the detection result to keep the chip from being damaged due to the inappropriate temperature. A common temperature sensing circuit may perform a sensing based on parameters of the circuit components thereof related to the temperature, e.g., a cross voltage of the circuit components. The cross voltages of the circuit components in different temperature sensing circuits may have different degrees of variation due to the variation of the temperature. If a calibration mechanism that can be executed quickly and maintain the accuracy at the same time is not presented, the cost of time for the calibration of the temperature sensing circuits increases.

### SUMMARY OF THE INVENTION

In consideration of the problem of the prior art, an object of the present invention is to supply a temperature sensing apparatus and a temperature sensing method having a calibration mechanism.

The present invention discloses a temperature sensing method having a calibration mechanism that includes steps outlined below. A first voltage digital code corresponding to a first temperature is configured by a processing circuit. A second voltage digital code corresponding to a second temperature is configured by the processing circuit. A base temperature is configured by the processing circuit, wherein a cross voltage of sensing circuit components in a temperature sensing circuit is a constant under the base temperature. A predetermined temperature difference between the first temperature and the second temperature is calculated and a predetermined digital code difference between the first voltage digital code and the second voltage digital code is calculated by the processing circuit so as to further calculate a predetermined slope according to a first ratio between the predetermined digital code difference and the predetermined temperature difference and establish a predetermined temperature and digital code relation equation. A sensing is performed by the temperature sensing circuit corresponding to the first temperature to generate an actual voltage digital code. A base temperature difference between the first temperature and the base temperature is calculated by the processing circuit. An actual digital code difference between the actual voltage digital code and the first voltage digital code is calculated, so as to further calculate a slope variation according to a second ratio between the actual digital code difference and the base temperature difference. The predetermined slope is calibrated according to the slope variation by the processing circuit to generate a calibrated slope to replace the predetermined slope in the predetermined temperature and digital code relation equation to generate an actual temperature and digital code relation equation. A temperature sensing is performed by using the temperature sensing circuit according to the actual temperature and digital code relation equation.

The present invention also discloses a temperature sensing apparatus having a calibration mechanism that includes a temperature sensing circuit and a processing circuit. The processing circuit is configured to execute a temperature sensing method that includes steps outlined below. A first voltage digital code corresponding to a first temperature is configured by a processing circuit. A second voltage digital code corresponding to a second temperature is configured by the processing circuit. A base temperature is configured by the processing circuit, wherein a cross voltage of sensing circuit components in the temperature sensing circuit is a constant under the base temperature. A predetermined temperature difference between the first temperature and the second temperature is calculated and a predetermined digital code difference between the first voltage digital code and the second voltage digital code is calculated by the processing circuit so as to further calculate a predetermined slope according to a first ratio between the predetermined digital code difference and the predetermined temperature difference and establish a predetermined temperature and digital code relation equation. A sensing is performed by the temperature sensing circuit corresponding to the first temperature to generate an actual voltage digital code. A base temperature difference between the first temperature and the base temperature is calculated by the processing circuit. An actual digital code difference between the actual voltage digital code and the first voltage digital code is calculated, so as to further calculate a slope variation according to a second ratio between the actual digital code difference and the base temperature difference. The predetermined slope is calibrated according to the slope variation by the processing circuit to generate a calibrated slope to replace the predetermined slope in the predetermined temperature and digital code relation equation to generate an actual temperature and digital code relation equation. A temperature sensing is performed by using the temperature sensing circuit according to the actual temperature and digital code relation equation.

These and other objectives of the present invention will no doubt become obvious to those of ordinary skill in the art behind reading the following detailed description of the preferred embodiments that are illustrated in the various figures and drawings.

### BRIEF DESCRIPTION OF THE DRAWINGS

FIG. 1 illustrates a block diagram of a temperature sensing apparatus having a calibration mechanism according to an embodiment of the present invention.

FIG. 2 illustrates a diagram depicting the relation between the temperature and the cross voltage of sensing circuit components in the temperature sensing circuit according to an embodiment of the present invention.

FIG. 3 illustrates a flow chart of a temperature sensing method having a calibration mechanism according to an embodiment of the present invention.

### DETAILED DESCRIPTION OF THE PREFERRED EMBODIMENTS

An aspect of the present invention is to provide a temperature sensing apparatus and a temperature sensing method having a calibration mechanism to use the characteristic that a cross voltage of sensing circuit components in the temperature sensing apparatus is a constant under the base temperature that is close to an absolute zero temperature, the sensing of the digital code and the calculation performed with a predetermined digital code are only required to be performed once for the temperature to be calibrated. The cost of time for the calibration of the temperature sensing circuits can be reduced while the accuracy of the calibration can be maintained.

Reference is now made to FIG. 1. FIG. 1 illustrates a block diagram of a temperature sensing apparatus 100 having a calibration mechanism according to an embodiment of the present invention. The temperature sensing apparatus 100 includes a temperature sensing circuit 110 and a processing circuit 120.

In an embodiment, a cross voltage of sensing circuit components in the temperature sensing circuit 110 is correlated to the variation of the temperature such that the temperature sensing circuit 110 generates corresponding digital codes under different temperatures according to the amount of the cross voltage. In an embodiment, such a cross voltage is a base-emitter voltage difference (V_{BE}) of a bipolar junction transistor (BJT) formed by a silicon material.

The processing circuit 120 is electrically coupled to the temperature sensing circuit 110 and includes computer executable commands to execute a temperature sensing having a calibration mechanism.

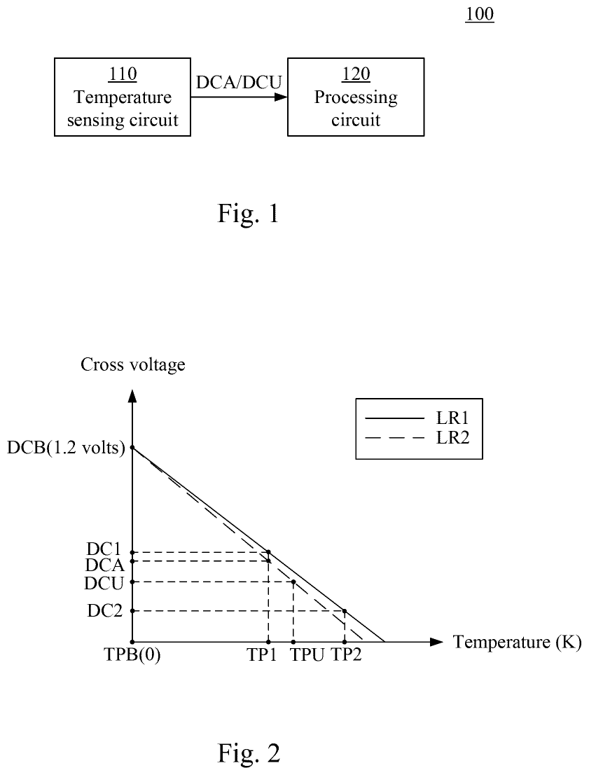

Reference is now made to FIG. 2. FIG. 2 illustrates a diagram depicting the relation between the temperature and the cross voltage of sensing circuit components in the temperature sensing circuit 110 according to an embodiment of the present invention. In FIG. 2, the X-axis represents the temperature and the unit thereof is the absolute temperature (K). The Y-axis represents the cross voltage and the unit thereof is a scale of the digital code.

Reference is made to FIG. 1 and FIG. 2 at the same time to describe the temperature sensing performed according to the cooperation of the processing circuit 120 and the temperature sensing circuit 110 in the following paragraphs.

A first voltage digital code DC1 corresponding to a first temperature TP1 in FIG. 2 is configured by the processing circuit 120. In an embodiment, the first temperature TP1 is 303.15 degrees absolute temperature (i.e., 30 degrees Celsius). The processing circuit 120 may configure the first voltage digital code DC1 corresponding to the first temperature TP1.

A second voltage digital code DC2 corresponding to a second temperature TP2 in FIG. 2 is configured by the processing circuit 120. In an embodiment, the second temperature TP2 323.15 degrees absolute temperature (i.e., 50 degrees Celsius). The processing circuit 120 may configure the second voltage digital code DC2 corresponding to the second temperature TP2.

A base temperature TPB in FIG. 2 is configured by the processing circuit 120, wherein a cross voltage of sensing circuit components in the temperature sensing circuit 110 is a constant under the base temperature TPB. In an embodiment, a difference between the base temperature TPB and absolute zero temperature is smaller than a predetermined range, e.g., a range within 5 degrees. In an embodiment, the base temperature TPB is very close to the absolute zero temperature. In an embodiment, the base temperature TPB can be the absolute zero temperature.

As illustrated in FIG. 2, the cross voltage in the form of the base-emitter voltage difference is 1.2 volts under the condition that the temperature is close to the absolute zero temperature. Along with the increasing of the temperature, different temperature sensing circuits 110 have linear relations LR1~LR2 having different slopes illustrated in FIG. 2 due to the variation of the manufacturing process, in which different cross voltages at the first temperature TP1 are presented such that different digital codes are generated.

As a result, for an ideal temperature sensing circuit 110, the processing circuit 120 may configure the base temperature TPB, in which the cross voltage is a constant, e.g., 1.2 volts, under the base temperature TPB. For simplicity, the base temperature TPB is illustrated to be the absolute zero temperature in FIG. 2. More specifically, even a slight variation of the manufacturing process is presented between different temperature sensing circuits 110 such that the cross voltages vary under a higher temperature, the cross voltages of the circuit components in these temperature sensing circuit 110 do not vary and are all 1.2 volts.

It is appreciated that the value described above is merely an example. practical implementation, the actual value of the base temperature may vary due to the configuration of the base temperature TPB.

At first, the processing circuit 120 performs a sensing under the first temperature TP1 and the second temperature TP2 to obtain the first voltage digital code DC1 and the second voltage digital code DC2 of the linear relation LR1, to calculate a predetermined temperature difference between the first temperature TP1 and the second temperature TP2 and a predetermined digital code difference between the first voltage digital code DC1 and the second voltage digital code DC2, so as to further calculate a predetermined slope SLP according to a first ratio between the predetermined digital code difference and the predetermined temperature difference.

SLP=(DC2−DC1)/(TP2−TP1) (equation 1)

The processing circuit 120 establishes the constant and a predetermined temperature and digital code relation equation according to the predetermined slope SLP to further establish the relation between the temperatures and the voltage digital codes of two points. When the voltage digital code is DC, the temperature is T, the constant is C and the predetermined slope is SLP, the predetermined temperature and digital code relation equation between the voltage digital code DC and the temperature T is represented by the following equation:

DC=SLP×T+C (equation 2)

The temperature sensing circuit 110 performs the sensing corresponding to the first temperature TP1 to generate an actual voltage digital code DCA. More specifically, as described above, the actual temperature sensing circuit 110 performs sensing corresponding to the first temperature TP1 to generate the actual voltage digital code DCA corresponding to the linear relation LR2 in FIG. 2.

The processing circuit 120 calculates an actual digital code difference between the actual voltage digital code DCA and the first voltage digital code DC1. Further, the processing circuit 120 calculates a base temperature difference between the first temperature TP1 and the base temperature TPB. The processing circuit 120 further calculates a slope variation SLV according to a second ratio between the actual digital code difference and the base temperature difference. The slope variation SLV can be expressed by the following equation:

SLV=(DCA−DC1)/(TP1−TPB) (equation 3)

The processing circuit 120 calibrates the predetermined slope SLP according to the slope variation SLV to generate a calibrated slope CLP. In an embodiment, the processing circuit 120 adds the slope variation SLV and the predetermined slope SLP to generate the calibrated slope CLP, which can be expressed by the following equation:

CLP=SLV+SLP (equation 4)

Such a calibration process of the slope is to calibrate the slope of the linear relation LR1 to approximate the linear relation LR2 by using the slope variation SLV.

The processing circuit 120 replaces the predetermined slope SLP in the predetermined temperature and digital code relation equation (i.e., the equation 2) by the calibrated slope CLP to generate an actual temperature and digital code relation equation, which can be expressed by the following equation:

DC=CLP×T+C (equation 5)

The processing circuit 120 performs the temperature sensing by using the temperature sensing circuit 110 according to actual temperature and digital code relation equation. More specifically, the temperature sensing performed by the processing circuit 120 includes performing the sensing on an under-sensing temperature TPU by the temperature sensing circuit 110 to generate an under-sensing voltage digital code DCU first. Subsequently, the processing circuit 120 substitutes the under-sensing voltage digital code DCU into the voltage digital code DC of the actual temperature and digital code relation equation to obtain:

DCU=CLP×TPU+C (equation 6)

After reordering (equation 6), the processing circuit 120 may obtain the calibrated sensing value of the under-sensing temperature TPU:

TPU=(DCU−C)/CLP (equation 7)

As a result, when the temperature sensing is performed, the processing circuit 120 may generate the under-sensing temperature TPU according to the actual linear relation LR2 of the temperature sensing circuit 110 based on the calibration mechanism.

The calibration mechanism and the temperature sensing performed by t processing circuit 120 are described by using a numerical example in the following paragraphs.

In such a numerical example, the first temperature TP1 is 303.15 degrees of the absolute temperature (30 degrees Celsius) and the second temperature TP2 is 323.15 degrees of the absolute temperature (50 degrees Celsius). The first voltage digital code DC1 is 100 and the second voltage digital code DC2 is 50. The predetermined slope SLP is obtained based on the calculation of (equation 1), which is (50/−20)=−2.5.

According to the predetermined slope SLP that is −2.5, when the calculated constant is 857.88, the predetermined temperature and digital code relation equation, which is (equation 2), becomes:

DC=(−2.5)×T+857.88

Moreover, when the actual voltage digital code DCA is 105 and the bas temperature TPB is 0.15, the slope variation SLV can be obtained from (equation 3), which is SLV=(105−100)/(303.15−0.15)=5/303=0.0165. Furthermore, the calibrated slope CLP can be obtained from (equation 4), which is CLP=−2.5+0.0165=−2.4835, in which the calibrated slope CLP, generated by calibrating the linear relation LR1 that the predetermined slope SLP corresponds to by using the slope variation SLV, approximates the linear relation LR2 that the actual temperature sensing corresponds to.

When the temperature sensing is performed to obtain the under-sensing voltage digital code DCU that is 90, the under-sensing temperature TPU can be obtained from (equation 7), which is TPU=(90−857.88)/(−2.4835)=309.19 degrees. As a result, the calibrated sensing value of the under-sensing temperature TPU is 309.19 degrees of the absolute temperature 309.19 (36.04 degrees Celsius).

In some approaches, the influence of the difference of the manufacturing process on the different temperature sensing circuits can be decreased by using a single-point calibration technology or a two-point calibration technology. However, the single-point calibration technology loses the accuracy since the digital codes corresponding to the temperatures that are more away from the calibration point diverge more. The two-point calibration technology is time-consuming since the chip of each of the temperature sensing circuits needs to be measured under different temperatures.

The temperature sensing apparatus having a calibration mechanism of t present invention uses the characteristic that a cross voltage of sensing circuit components in the temperature sensing apparatus is a constant under the base temperature that is close to an absolute zero temperature, the sensing of the digital code and the calculation performed with a predetermined digital code are only required to be performed once for the temperature to be calibrated. The cost of time for the calibration of the temperature sensing circuits can be reduced while the accuracy of the calibration can be maintained.

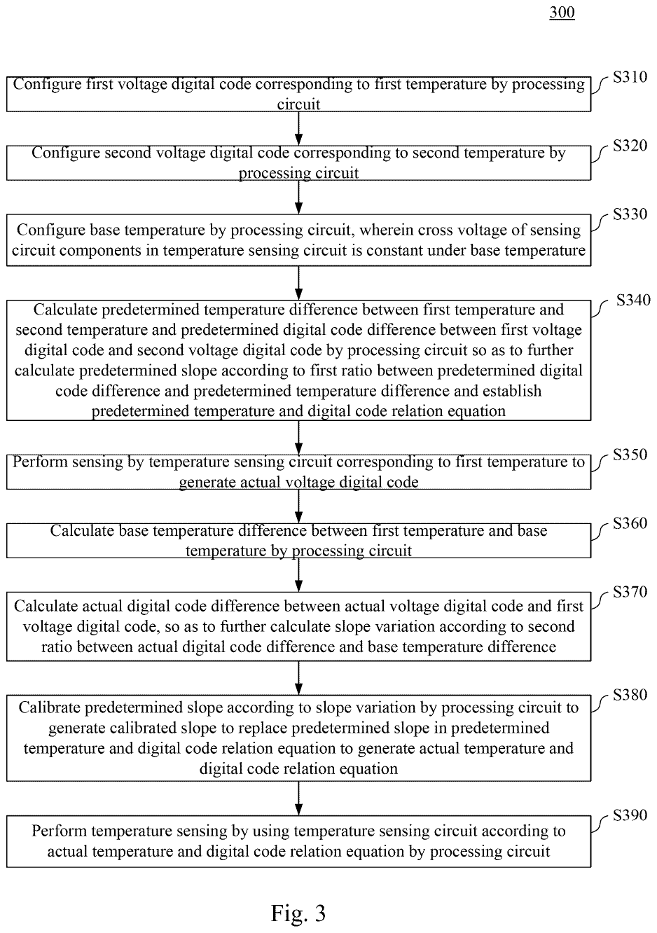

Reference is now made to FIG. 3. FIG. 3 illustrates a flow chart of a temperature sensing method 300 having a calibration mechanism according to an embodiment of the present invention.

In addition to the apparatus described above, the present disclosure further provides the temperature sensing method 300 having a calibration mechanism that can be used in such as, but not limited to, the temperature sensing apparatus 100 in Fig . As illustrated in FIG. 3, an embodiment of the temperature sensing method 300 includes the following steps.

In step S310, the first voltage digital code DC1 corresponding to the first temperature TP1 is configured by the processing circuit 120.

In step S320, the second voltage digital code DC2 corresponding to the second temperature TP2 is configured by the processing circuit 120.

In step S330, the base temperature TPB is configured by the processing circuit 120, wherein the cross voltage of sensing circuit components in the temperature sensing circuit is the constant under the base temperature TPB.

In step S340, the predetermined temperature difference between the first temperature TP1 and the second temperature TP2 is calculated and the predetermined digital code difference between the first voltage digital code DC1 and the second voltage digital code DC2 is calculated by the processing circuit 120 so as to further calculate the predetermined slope SLP according to the first ratio between the predetermined digital code difference and the predetermined temperature difference and establish the predetermined temperature and digital code relation equation.

In step S350, the sensing is performed by the temperature sensing circuit 110 corresponding to the first temperature TP1 to generate the actual voltage digital code DCA.

In step S360, the base temperature difference TPB between the first temperature TP1 and the base temperature TPB is calculated by the processing circuit 120.

In step S370, the actual digital code difference between the actual voltage digital code DCA and the first voltage digital code DC1 is calculated, so as to further calculate the slope variation SLV according to the second ratio between the actual digital code difference and the base temperature difference.

In step S380, the predetermined slope SLP is calibrated according to the slope variation SLV by the processing circuit 120 to generate the calibrated slope CLP to replace the predetermined slope SLP in the predetermined temperature and digital code relation equation to generate the actual temperature and digital code relation equation.

In step S390, the temperature sensing is performed by using the temperature sensing circuit 110 according to the actual temperature and digital code relation equation by the processing circuit 120.

It is appreciated that the embodiments described above are merely an example. In other embodiments, it should be appreciated that many modifications and changes may be made by those of ordinary skill in the art without departing, from the spirit of the disclosure.

In summary, the present invention discloses the temperature sensing apparatus and the temperature sensing method having the calibration mechanism that use the characteristic that a cross voltage of sensing circuit components in the temperature sensing apparatus is a constant under the base temperature that is close to an absolute zero temperature, the sensing of the digital code and the calculation performed with a predetermined digital code are only required to be performed once for the temperature to be calibrated. The cost of time for the calibration of the temperature sensing circuits can be reduced while the accuracy of the calibration can be maintained.

The aforementioned descriptions represent merely the preferred embodiment of the present invention, without any intention to limit the scope of the present invention thereto. Various equivalent changes, alterations, or modifications based on the claims of present invention are all consequently viewed as being embraced by the scope of the present invention.

What is claimed is:

1. A temperature sensing method having a calibration mechanism, comprising:
configuring a first voltage digital code corresponding to a first temperature by a processing circuit;
configuring a second voltage digital code corresponding to a second temperature by the processing circuit;
configuring a base temperature by the processing circuit, wherein a cross voltage of sensing circuit components in a temperature sensing circuit is a constant under the base temperature;
calculating a predetermined temperature difference between the first temperature and the second temperature and a predetermined digital code difference between the first voltage digital code and the second voltage digital code by the processing circuit so as to further calculate a predetermined slope according to a first ratio between the predetermined digital code difference and the predetermined temperature difference and establish a predetermined temperature and digital code relation equation according to the predetermined slope;
performing a sensing by the temperature sensing circuit corresponding to the first temperature to generate an actual voltage digital code;
calculating a base temperature difference between the first temperature and the base temperature by the processing circuit;
calculating an actual digital code difference between the actual voltage digital code and the first voltage digital code by the processing circuit, so as to further calculate a slope variation according to a second ratio between the actual digital code difference and the base temperature difference;
calibrating the predetermined slope according to the slope variation by the processing circuit to generate a calibrated slope to replace the predetermined slope in the predetermined temperature and digital code relation equation to generate an actual temperature and digital code relation equation; and
performing a temperature sensing by using the temperature sensing circuit according to the actual temperature and digital code relation equation.

2. The temperature sensing method of claim 1, further comprising:
adding the slope variation and the predetermined slope to generate the calibrated slope by the processing circuit.

3. The temperature sensing method of claim 2, wherein the temperature sensing further comprises:
performing the sensing on an under-sensing temperature by the temperature sensing circuit to generate an under-sensing voltage digital code; and
substituting the under-sensing voltage digital code into the actual temperature and digital code relation equation by the processing circuit to obtain a calibrated sensing value of the under-sensing temperature.

4. The temperature sensing method of claim 1, wherein a voltage digital code is DC, a temperature is T, a constant is C, the predetermined slope is SLP and the calibrated slope is CLP, the predetermined temperature and digital code relation equation is DC=SLP×T+C, and the actual temperature and digital code relation equation is DC=CLP×T+C.

5. The temperature sensing method of claim 1, wherein a difference between the base temperature and an absolute zero temperature is smaller than a predetermined range.

6. The temperature sensing method of claim 5, wherein the cross voltage of sensing circuit components is a base-emitter voltage difference of a bipolar junction transistor formed by a silicon material.

7. A temperature sensing apparatus having a calibration mechanism, comprising:
a temperature sensing circuit; and
a processing circuit configured to execute a temperature sensing method, comprising:
configuring a first voltage digital code corresponding to a first temperature;
configuring a second voltage digital code corresponding to a second temperature;
configuring a base temperature, wherein a cross voltage of sensing circuit components in the temperature sensing circuit is a constant under the base temperature;
calculating a predetermined temperature difference between the first temperature and the second temperature and a predetermined digital code difference between the first voltage digital code and the second voltage digital code so as to further calculate a predetermined slope according to a first ratio between the predetermined digital code difference and the predetermined temperature difference and establish a predetermined temperature and digital code relation equation according to the predetermined slope;
performing a sensing by the temperature sensing circuit corresponding to the first temperature to generate an actual voltage digital code;
calculating a base temperature difference between the first temperature and the base temperature;
calculating an actual digital code difference between the actual voltage digital code and the first voltage digital code, so as to further calculate a slope variation according to a second ratio between the actual digital code difference and the base temperature difference;
calibrating the predetermined slope according to the slope variation to generate a calibrated slope to replace the predetermined slope in the predetermined temperature and digital code relation equation to generate an actual temperature and digital code relation equation; and
performing a temperature sensing by using the temperature sensing circuit according to the actual temperature and digital code relation equation.

8. The temperature sensing method of claim 7, further comprising:
adding the slope variation and the predetermined slope to generate the calibrated slope by the processing circuit.

9. The temperature sensing method of claim 8, wherein the temperature sensing further comprising:
performing the sensing on an under-sensing temperature by the temperature sensing circuit to generate an under-sensing voltage digital code; and
substituting the under-sensing voltage digital code into the actual temperature and digital code relation equation by the processing circuit to obtain a calibrated sensing value of the under-sensing temperature.

10. The temperature sensing method of claim 7, wherein a voltage digital code is DC, a temperature is T, a constant is C, the predetermined slope is SLP and the calibrated slope is CLP, the predetermined temperature and digital code relation equation is DC=SLP×T+C, and the actual temperature and digital code relation equation is DC=CLP×T+C.

11. The temperature sensing method of claim 7, wherein a difference between the base temperature and an absolute zero temperature is smaller than a predetermined range.

12. The temperature sensing method of claim 11, wherein the cross voltage of sensing circuit components is a base-emitter voltage difference of a bipolar junction transistor formed by a silicon material.
